(19) United States
(12) Patent Application Publication
(10) Pub. No.: US 2003/0128488 A1
(43) Pub. Date: Jul. 10, 2003

(54) Electric appliance capable of receiving power from a battery or an external source

(76) Inventors: Uwe Katzer, Eppstein-Vockenhausen (DE); Peter Trawinski, Weiterstadt (DE); Lothar Pacher, Mainz (DE)

Correspondence Address: PAUL A. PYSHER, Fish & Richardson P.C., 225 Franklin Street, Boston, MA, 02110-2804, US

(21) Appl. No.: 10/319,193

(22) Filed: Dec. 13, 2002

Related U.S. Application Data
(63) Continuation of application No. PCT/EP01/11772, filed on Oct. 11, 2001.

(30) Foreign Application Priority Data
Oct. 20, 2000 (DE) 100 52 374.9

(51) Int. Cl. H02H 3/24

(52) U.S. Cl. 361/92

(57) ABSTRACT

An electric appliance is capable of receiving voltage from an energy source. The appliance includes a battery, a load element that is operable from the battery or the energy source, and a control circuit. The control circuit includes a variable resistance element that can be adjusted so that voltage received from the energy source does not drop below a predetermined minimum voltage.

### CROSS-REFERENCE TO RELATED APPLICATIONS

This application is a continuation of PCT Application No. PCT/EP01/11772, filed on Oct. 11, 2001, which claims priority to German Application No. 10052374.9, filed on Oct. 20, 2000. The contents of PCT Application No. PCT/EP01/11772 and German Application No. 10052374.9 are hereby incorporated by reference into this application as if set forth herein in full.

### TECHNICAL FIELD

This application relates generally to a small electric appliance having a battery and a load element, the small electric appliance being capable of receiving power from either the battery or from an external energy source.

### BACKGROUND

European Patent Application No EP0875978A describes a battery-operated electric appliance, which includes an electronic circuit and a battery that can be charged using a charging device. When the battery is totally discharged, the battery may draw a large amount of current from the charging device, causing its voltage to collapse.

During battery charging, the electronic circuit can be supplied with a sufficiently high voltage. This voltage is provided by a capacitor that is charged by the charging device via a diode. An electronic switch repeatedly interrupts charging of the battery for brief periods of time. This causes the battery to be taken off the charging device so that its voltage increases and the capacitor is charged via the diode. Thus, the battery is not charged continuously during its charging cycle.

### SUMMARY

In general, in one aspect, the invention is directed to an electric appliance that is capable of receiving voltage from an energy source. The electric appliance includes a battery, a load element that is operable from the battery or the energy source, and a control circuit. The control circuit includes a variable resistance element that can be adjusted so that voltage received from the energy source does not drop below a predetermined minimum voltage. This aspect of the invention may also include one or more of the following features.

The variable resistance element may lie in a path of current that charges the battery. The variable resistance may include a transistor. A resistance of the variable resistance element can vary continuously or incrementally.

The appliance may include a positive voltage booster circuit. The load element may be supplied by the energy source via the positive voltage booster circuit. The load element may be supplied with voltage from the battery or the energy source. The load element may be supplied by the battery via the positive booster circuit. The control circuit may measure the voltage applied to the load element or the voltage delivered by the energy source.

Other features and advantages of the invention will become apparent from the following description, including the claims and drawings.

### DESCRIPTION OF THE DRAWINGS

FIG. 1 shows a first small electric appliance having a first circuit arrangement.

FIG. 2 shows a second small electric appliance having a second circuit arrangement.

FIG. 3 shows a third small electric appliance having a third circuit arrangement.

Like reference numerals in different figures indicate like elements.

### DESCRIPTION

Described herein is a small electric appliance, which includes a battery and a load element. As set forth below, even when the appliance is powered by a high-resistance external energy source, the battery may be continuously supplied with a charging current and the load element may be continuously supplied with a sufficiently high voltage.

In one embodiment, the appliance includes a control circuit for controlling a voltage provided to the appliance by the external energy source. The voltage may be controlled by varying a resistance of a circuit through which current flows to charge the battery. To this end, the appliance may include a variable resistance circuit (e.g., control circuit 4 described below), through which the battery can be charged by the external energy source.

In order to adjust the variable resistance to a proper level, the control circuit measures the voltage delivered by the energy source or the voltage supplied to the load element. The latter is particularly advantageous if the load element is, e.g., supplied by the energy source via a positive voltage booster circuit. Thus, when the energy source is not connected to the small electric appliance, the load element can be supplied directly by the battery or via the positive voltage booster circuit.

As described below, the variable resistance circuit may include at least one transistor that can be controlled by the control circuit and that makes it possible to alter the resistance through which the battery charging current flows either variably (continuously) or incrementally.

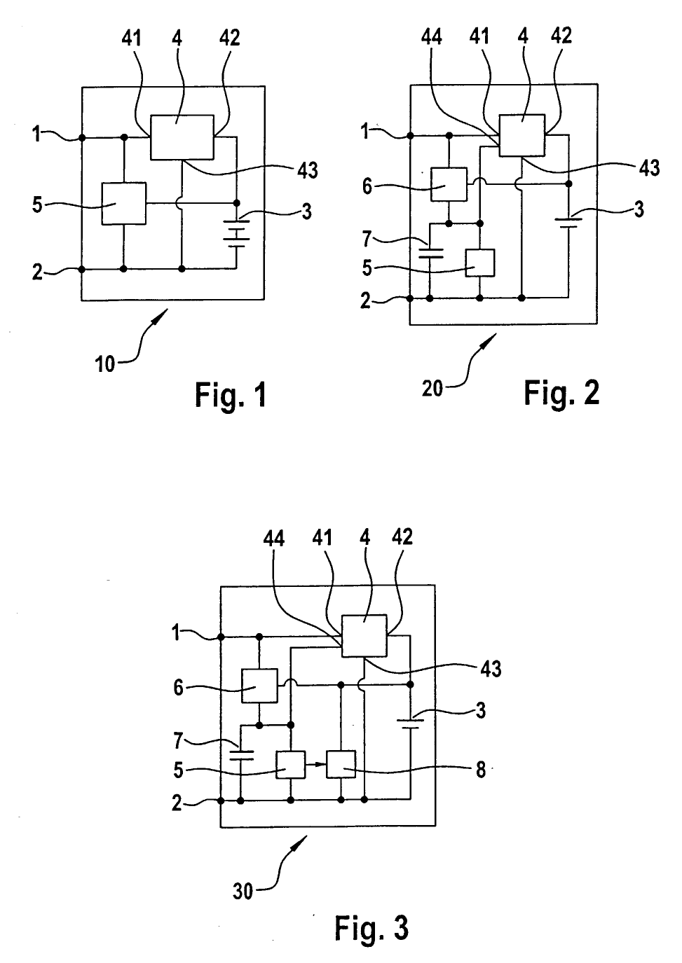

FIG. 1 shows a first small electric appliance 10. Appliance 10 includes two terminals 1, 2, which can be connected to an (e.g., external) energy source, such as a charging device (not shown in FIG. 1). Appliance 10 also includes a battery 3, a control circuit 4, and a load element 5 that is connected to terminals 1, 2. Battery 3 may be a single-cell or multi-cell battery.

Control circuit 4 includes an input 41 at one terminal, an output 42 at another terminal, and a power supply terminal 43. Output 42 is connected to load element 5 and to one pole of battery 3. The other pole of battery 3 is connected to one of terminals 1, 2 (in this embodiment, terminal 2). Load element 5 is operated using the higher of the two available operating voltages, namely, either the voltage of battery 3 or a supply voltage provided by the external energy source (not shown).

Control circuit 4 contains a reference voltage source (not shown) that generates a reference voltage from the supply voltage tapped between its input 41 and its power supply terminal 43. Control circuit 4 also contains a comparator (not shown) that compares the reference voltage with the supply voltage. In this way, control circuit 4 measures the voltage delivered by the energy source. In accordance with this measurement, control circuit 4 adjusts a variable resistance arranged between input 41 and output 42 of control circuit 4. This variable resistance may be implemented using the collector-emitter resistance of a bipolar transistor (not shown), or the source-drain resistance of a field effect transistor (not shown).

Control circuit 4 adjusts the value of the variable resistance in such a way that the voltage, at its input 41, does not fall short of a predetermined minimum voltage. Control circuit 4 is also configured so that the variable resistance assumes its maximum value when the voltage at input 41 is minimal, e.g., zero.

FIG. 2 shows a second small electric appliance 20. Appliance 20 of FIG. 2 differs from the appliance 10 of FIG. 1 in that appliance 20 includes a positive voltage booster circuit 6 and a capacitor 7. In addition, control circuit 4 of appliance 20 has a second input 44. Second input 44 is connected to the point at which load element 5 and positive voltage booster circuit 6 are interconnected. Positive voltage booster circuit 6 is disposed between this interconnecting point and one terminal (terminal 1 in FIG. 2). Load element 5 is disposed between the interconnecting point and the other terminal (terminal 2 in FIG. 2).

Capacitor 7 is arranged in parallel to load element 5. Output 42 of control circuit 4 is not connected to load element 5, but rather to positive voltage booster circuit 6 and to one pole of battery 3. The other pole of battery 3 is connected to one of the terminals 1, 2 (terminal 2 in FIG. 2). Positive voltage booster circuit 6 boosts either the voltage of battery 3 or the supply voltage delivered by the energy source. In this embodiment, positive voltage booster circuit 6 boosts the higher of these two voltages.

Appliance 20 has an advantage over appliance 10. That is, positive voltage booster circuit 6 permits a higher operating voltage for load element 5. The higher operating voltage is also smoothed by capacitor 7. The voltage smoothing is particularly advantageous if the supply voltage delivered by the energy source is rectified AC (Alternating Current) voltage having ripple.

It is also advantageous in that control circuit 4 ensures that the operating voltage applied to the second input 44 does not drop below a predetermined minimum voltage. This permits increased voltage control accuracy by control circuit 4. In addition, the reference voltage can be generated from the higher operating voltage instead of the supply voltage applied to the terminals 1, 2.

FIG. 3 shows a third small electric appliance 30. Appliance 30 of FIG. 3 differs from appliance 20 of FIG. 2 in that appliance 30 includes a load 8 that is arranged in parallel to battery 3 and that can be switched on and off by load element 5. In one embodiment of appliance 30, such as an electric toothbrush, load element 5 includes an electronic circuit (not shown), and load 8 includes a serial circuit (not shown) comprised of a DC (Direct Current) motor (not shown) and a controllable switch (not shown). The controllable switch may be, e.g., a field effect transistor (FET) that can be controlled by the electronic circuit. The electronic circuit may be integrated on a semiconductor chip together with control circuit 4, positive voltage booster circuit 6 and, if applicable, the controllable switch.

In other embodiments of control circuit 4, the variable resistance may include several transistors. The collector-emitter paths or source-drain paths of such transistors may be switched between input 41 and output 42 of control circuit 4, i.e., parallel to one another. The transistors may be switched either in the conductive state or the non-conductive state by control circuit 4.

The resistances of these paths may be chosen differently in the conductive state of the transistors. The effective resistance between input 41 and output 42 can be altered in increments by either triggering only one transistor with a high path resistance or triggering one transistor with a low path resistance, or by triggering several or all transistors at the same time.

The invention is described above with reference to generic embodiments of small electric appliances. Examples of such appliances may include, but art not limited to, electric shavers, electric toothbrushes, electronic entertainment devices, data processing devices, data transmission devices, computers, and the like.

Other embodiments not described herein are also within the scope of the following claims.

What is claimed is:

1. An electric appliance capable of receiving voltage from an energy source, the electric appliance comprising:
a battery;
a load element that is operable from the battery or the energy source; and
a control circuit, the control circuit including a variable resistance element that can be adjusted so that voltage received from the energy source does not drop below a predetermined minimum voltage.

2. The electric appliance of claim 1, wherein the variable resistance element lies in a path of current that charges the battery.

3. The electric appliance of claim 1, wherein the variable resistance comprises a transistor.

4. The electric appliance of claim 1, wherein a resistance of the variable resistance element can vary continuously or incrementally.

5. The electric appliance of claim 1, further comprising:
a positive voltage booster circuit,
wherein the load element is supplied by the energy source via the positive voltage booster circuit.

6. The electric appliance of claim 1, wherein the load element is supplied with voltage from the battery or the energy source.

7. The electric appliance of claim 1, further comprising:
a positive voltage booster circuit;
wherein the load element is supplied by the battery via the positive booster circuit.

8. The electric appliance of claim 1, wherein the control circuit measures the voltage applied to the load element or the voltage delivered by the energy source.
